(19) United States
(12) Patent Application Publication
(10) Pub. No.: US 2025/0184357 A1
(43) Pub. Date: Jun. 5, 2025

(54) Systems and Methods for Expanding the Security Context of AI

(71) Applicant: Cisco Technology, Inc., San Jose, CA (US)

(72) Inventors: Hendrikus G. P. Bosch, Aalsmeer (NL); Marc Scibelli, Trumbull, CT (US); Jeffrey Michael Napper, Delft (NL); Pete Rai, Egham (GB); Andre Jean Marie Surcouf, Saint Leu La Foret (FR); Reginaldo Emanuel Ribeiro Costa, Epalinges (CH); Vijoy A. Pandey, San Jose, CA (US); Tali Tal Livni, Karmiel (IL)

(21) Appl. No.: 18/428,774

(22) Filed: Jan. 31, 2024

Related U.S. Application Data
(60) Provisional application No. 63/605,073, filed on Dec. 1, 2023.

(51) Int. Cl. H04L 9/40; G06F 9/451; G06N 3/0895

(52) U.S. Cl. CPC H04L 63/20; G06F 9/451; G06N 3/0895

(57) ABSTRACT

In one embodiment, a method includes receiving a selection of a UI element from a UI and determining a context associated with the UI element. The method also includes receiving an inquiry associated with the UI element and communicating the inquiry and the context to one or more language models. The method further includes receiving, by the one or more language models, a response to the inquiry using the inquiry and the context.

### RELATED APPLICATIONS

This application claims priority to U.S. Provisional Patent Application No. 63/605,073 filed Dec. 1, 2023, which is hereby incorporated by reference in its entirety.

### TECHNICAL FIELD

The present disclosure relates generally to security contexts, and more specifically to systems and methods for expanding the security context of artificial intelligence (AI).

### BACKGROUND

A security solution may analyze an application that is being hosted on a cloud system to discover vulnerabilities, misconfigurations, and mishaps in that application, its cloud environment, the continuous integration and continuous delivery/continuous deployment (CI/CD) pipeline, and storage systems. To understand how an attacker can gain access to that application and/or compromise the application, the security solution may find attack paths/kill chains to the application. The attack paths/kill chains represent steps attackers may take to steal central processing unit (CPU) power, create general mayhem in the application, steal data, etc.

### BRIEF DESCRIPTION OF THE FIGURES

FIG. 1 illustrates a system for expanding the security context of AI, in accordance with certain embodiments.

FIG. 2 illustrates a screenshot of an AI assistant used by the system of FIG. 1, in accordance with certain embodiments.

FIG. 3 illustrates a screenshot of a chat box and a dialog box used by an AI assistant to communicate with a user, in accordance with certain embodiments.

FIG. 4 illustrates another screenshot of a chat box and a dialog box used by an AI assistant to communicate with a user, in accordance with certain embodiments.

FIG. 5 illustrates a screenshot of a chat box generated by the AI assistant of FIG. 1 that includes a user inquiry and a user selection, in accordance with certain embodiments.

FIG. 6 illustrates an example method for expanding the security context of AI, in accordance with certain embodiments.

FIG. 7 illustrates a computer system that may be used by the systems and methods described herein, in accordance with certain embodiments.

### DESCRIPTION OF EXAMPLE EMBODIMENTS

### Overview

This disclosure describes systems and methods for expanding the security context of AI. When a security tool is combined with an AI, such as AI based on language model technologies such as large language model (LLM) and/or a small language model (SLM), the AI can serve as a security sidekick to assist security personnel in better formulating security queries, combining static and dynamic security information in new ways, and/or automatically remediating security issues.

According to an embodiment, a network component includes one or more processors and one or more computer-readable non-transitory storage media coupled to the one or more processors and including instructions that, when executed by the one or more processors, cause the network component to perform operations. The operations include a receiving a selection of a user interface (UI) element from a UI and determining a context associated with the UI element. The operations also include receiving an inquiry associated with the UI element and communicating the inquiry and the context to one or more language models. The operations further include receiving, by the one or more language models, a response to the inquiry using the inquiry and the context.

In certain embodiments, receiving the selection of the UI element from the UI includes receiving an identifier associated with the UI element. In some embodiments, determining the context associated with the UI element includes determining a service associated with the identifier, onboarding the service, and/or generating a call to the service to obtain the context.

In certain embodiments, the operations include receiving the inquiry from a chat box of the UI. The inquiry may include a question in the form of a natural language. In some embodiments, the operations include associating the inquiry with the context.

In some embodiments, the one or more language models may include an LLM and/or an SLM. In certain embodiments, the operations include training the SLM with specifics of application programming interfaces (APIs) and their associated rules and/or deciphering, by the SLM, the context to assist the one or more language models with generating the response to the inquiry.

In certain embodiments, the operations include displaying one or more available UI elements to the user via the UI and/or receiving, in response to displaying the one or more available UI elements to the user via the UI, the selection of the context.

In some embodiments, the operations include capturing the response to the inquiry and/or sharing the response to the inquiry with one or more other UIs that are authorized to display the context and response to the inquiry.

According to another embodiment, a method includes receiving a selection of a UI element from a UI and determining a context associated with the UI element. The method also includes receiving an inquiry associated with the UI element and communicating the inquiry and the context to one or more language models. The method further includes receiving, by the one or more language models, a response to the inquiry using the inquiry and the context.

According to yet another embodiment, one or more computer-readable non-transitory storage media embody instructions that, when executed by a processor, cause the processor to perform operations. The operations include a receiving a selection of a UI element from a UI and determining a context associated with the UI element. The operations also include receiving an inquiry associated with the UI element and communicating the inquiry and the context to one or more language models. The operations further include receiving, by the one or more language models, a response to the inquiry using the inquiry and the context.

Technical advantages of certain embodiments of this disclosure may include one or more of the following. This disclosure describes systems and methods for expanding the security context of AI. Certain systems and methods described herein may allow extending the security context of AI with user selectable information. Certain systems and methods described herein may allow expanding the security context of AI using deductive reasoning to dissect natural language queries. Certain systems and methods described herein may allow sharing the security context of AI across multiple users. Certain systems and methods described herein use an AI assistant to expand the security context, which may save the associated entity time and money. The use of an AI assistant to expand the security context may also make predictions and/or answer questions faster and more precisely than a user.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

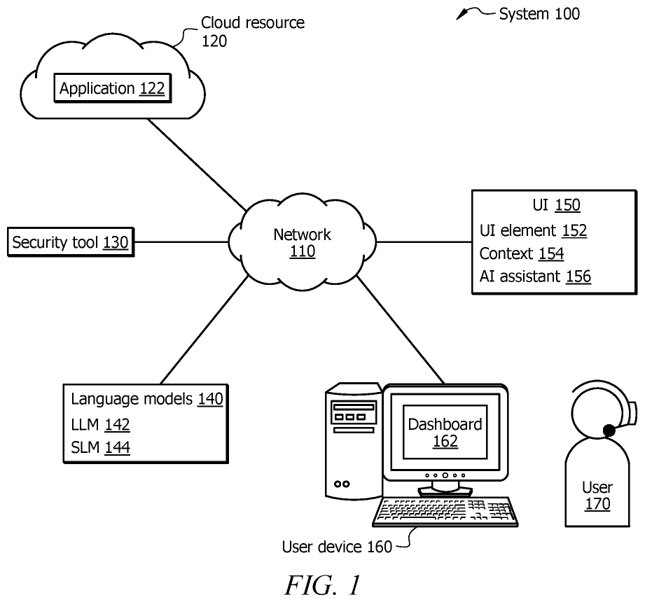

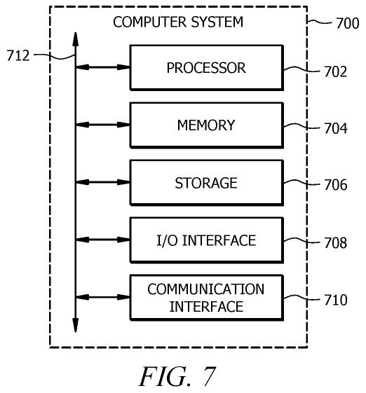

FIG. 1 illustrates a system 100 for expanding the security context of AI. System 100 or portions thereof may be associated with an entity, which may include any entity, such as a business, company, or enterprise, that expands the security context of AI. In certain embodiments, the entity may be a service provider that provides security services. The components of system 100 may include any suitable combination of hardware, firmware, and software. For example, the components of system 100 may use one or more elements of the computer system of FIG. 7. In the illustrated embodiment of FIG. 1, system 100 includes a network 110, a cloud resource 120, an application 122, a security tool 130, language models 140 (LLM 142 and SLM 144), a UI 150, a UI element 152, a context 154, an AI assistant 156, a user device 160, a dashboard 162, and a user 170.

Network 110 of system 100 represents any type of network that facilitates communication between components of system 100. Network 110 may connect one or more components of system 100. One or more portions of network 110 may include an ad-hoc network, the Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a portion of the Public Switched Telephone Network (PSTN), a cellular telephone network, a Digital Subscriber Line (DSL), an Multiprotocol Label Switching (MPLS) network, a 3G/4G/5G network, a Long Term Evolution (LTE) network, a cloud network, a combination of two or more of these, or other suitable types of networks. Network 110 may include one or more different types of networks. Network 110 may be any communications network, such as a private network, a public network, a connection through the Internet, a mobile network, a WI-FI network, etc. Network 110 may include a core network, an access network of a service provider, an Internet service provider (ISP) network, and the like. One or more components of system 100 may communicate over network 110.

Network 110 may include one or more nodes. Nodes are connection points within network 110 that receive, create, store and/or send data along a path. Nodes may include one or more redistribution points that recognize, process, and forward data to other nodes of network. Nodes may include virtual and/or physical nodes. In certain embodiments, nodes include one or more virtual machines, hardware devices, bare metal servers, and the like. In some embodiments, nodes may include data communications equipment such as computers, routers, servers, printers, workstations, switches, bridges, modems, hubs, and the like. Nodes may use static and/or dynamic routing to send data to and/or receive data to other nodes of system 100.

Cloud resource 120 represents any cloud computing platform. Cloud resource 120 may provide cloud services such as computing services, data storage services, data analytics services, machine learning services, and so on. In certain embodiments, cloud resource 120 provides on-demand cloud computing and/or APIs to companies, individuals, governments, etc. In some embodiments, cloud resource 120 provides management tools. Cloud resource 120 may provide access, management, and/or the development of applications and/or services through global data centers. Examples of cloud resource 120 include Amazon Web Services (AWS), Microsoft Azure, Google Cloud Platform (GCP), Oracle Cloud Infrastructure (OCI), and the like. In the illustrated embodiment of FIG. 1, cloud resource hosts application 122.

Application 122 of system 100 represents any computer program designed to carry out a specific task, usually for the benefit of an end user (e.g., user 170). In certain embodiments, cloud resource 120 hosts application 122 on one or more dedicated physical servers and/or virtual machines (VMs) on behalf of the customer. Examples of application 122 include a word processing application, a media player application, an accounting software application, a security application (e.g., an antivirus or cybersecurity application), an c-commerce application (Amazon, eBay, etc.), a web application, a meeting application (e.g., WebEx or Zoom), a social media application (e.g., Facebook), a data storage application (e.g., Dropbox), a software as a service (SAAS) application, an infrastructure as a service (IAAS) application, a platform as a service application (PAAS) application, or any other suitable type of application 122.

Security tool 130 of system 100 is a software program that is used to expand the security context of AI. In certain embodiments, security tool 130 is a cloud native application security solution that is used to assist user 170 in creating and/or maintaining secure, compliant cloud native applications. In some embodiments, security tool 130 performs an attack path analysis for application 122 by observing paths from diverse angles and gaining insight with risk mitigation and resolution. Security tool 130 may be used for code and/or continuous integration and CI/CD security to obtain real-time vulnerability detection from development to runtime. Security tool 130 may be used for cloud workload protection (CWP) by scaling across environments and prioritizing real-time risks for cloud workloads.

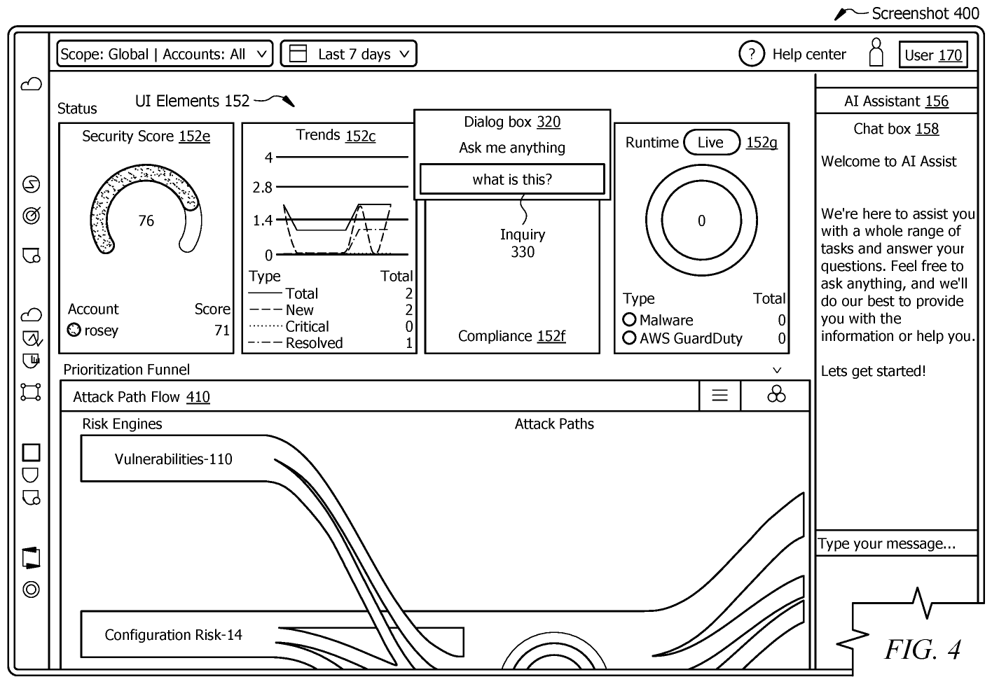

In certain embodiments, security tool 130 includes one or more aspects of a cloud-native application protection platform (CNAPP). A CNAPP is a cloud-native security model that encompasses cloud security posture management (CSPM), cloud service network security (CSNS), and cloud workload protection platform (CWPP) in a single holistic platform. CSPM may be used to scan, monitor, and/or remediate critical attack paths in the cloud stack instantly. CNAPP may be used to calculate attack paths (e.g., attack path flow 410 of FIG. 4), perform an attack path analysis across application 122 and/or cloud resource 120, discover problems (e.g., configuration issues) in the cloud security posture of application 122, manage the orchestration of application 122 hosted in cloud resource 120, and so on.

In some embodiments, security tool 130 implements one or more aspects of data security posture management (DSPM). DSPM may be used to understand security issues of application 122. In certain embodiments, DSPM is triggered from a cloud security posture management (CSPM). When the CSPM discovers data sources, the DSPM may classify the data and/or correlate the data with attack paths that are triggered (e.g., by way of vulnerabilities, cloud security, etc.).

In some embodiments, security tool 130 includes one or more aspects of Kubernetes Security Posture Management (KSPM), which uses security automation tools to discover and fix security and compliance issues within any component of Kubernetes. In certain embodiments, security tool 130 leverages one or more language models 140.

Language models 140 of system 100 represent probabilistic models of natural languages. Language models 140 may be used for tasks such as machine translation, natural language generation, optical character recognition, handwriting recognition, grammar induction, information retrieval, speech recognition, and so on. Language models 140 of system 100 include a large language model (LLM) 142 and a small language model (SLM) 144.

LLM 142 of system 100 represents a kind of AI algorithm that uses deep learning techniques and massively large data sets to understand, summarize, generate, and/or predict new content. In certain embodiments, LLM 142 performs general-purpose language understanding and generation. In some embodiments, LLM 142 is an artificial neural network (e.g., a transformer) that is trained using self-supervised learning and/or semi-supervised learning. Examples of LLM 142 include ChatGPT and Google Bard.

SLM 144 of system 100 represents a lightweight generative AI model that is a smaller version of LLM 142. SLM 144 is classified as such based on the size of its neural network, the number of parameters SLM 144 uses to make a decision, and the volume of data SLM 144 is trained on. SLM 144 require less computational power and memory than LLM 142, which may make SLM 144 more suitable for certain types of deployments. In some embodiments, SLM 144 is designed to process data locally, which may be helpful for organizations that need to comply with privacy and/or security policies.

In certain embodiments, SLM 144 is trained to perform deductive reasoning. For example, SLM may be trained to infer conclusions from known information based on formal logic rules. SLM may be trained with specifics of APIs and rules in which the APIs need to be combined into a comprehensive answer. In some embodiments, SLM 144 assists LLM in generating one or more responses to inquiries.

A non-limiting example of SLM 144 performing deductive reasoning to assist in generating responses is as follows: messages=[{“role”: “system”, “content”: “You are an AI assistant in a cloud security (Cloud-native application protection platform) CNAPP platform that helps people find security information. \n” \ “A CNAPP can calculate an attack path, or attack-path analysis (APA), across the application and clouds used.\n” \ “A CNAPP finds problems in an application's cloud security posture, which helps to find specific configuration \n” \ “issues when applications are hosted on cloud resources. In case a cloud is misconfigured, hackers can gain access to the specific resources \n” \ “to steal CPU, data or create application mayhem.\n” \ “Typically applications hosted \n” \ “are deployed as images, and yes, if images have vulnerabilities (=CVEs), then first the image can be hacked, then KSPM and then cloud. These \n” \ “latter issues with images are typically found with workload protection security.\n” \ “A KSPM manages the orchestration of applications managed \n” \ “by Kubernetes hosted on a cloud. If Kubernetes is poorly configured, hackers can gain access to the application's deployment infrastructures, and, when the \n” \ “underlying cloud is also poorly configured, steal resources of the underlying cloud by first mishandling KSPM. \n” \ “A DSPM understands the security issues in applications. The DSPM can be triggered from the CSPM and when the CSPM finds data sources, the \n” \ “DSPM then (a) classifies the data and (b) correlates it with attack paths that are triggered, e.g., by way of vulnerabilities or cloud security \n” \ “issues. \n” \ “\n” \ “Then, note I have a set of tools to answer questions on. The number signifies the priority order: \n” \ “1-APA-attack paths can be pulled from the entire application\n” \ “8-comics-a tool that helps me find random or specific comics \n” \ “7-Jira-a tool that manages work orders for teams of programmers\n” \ “3-CWP-workload protection security, a tool that helps find security problems inside applications, images and SBOMs \n” \ “4—KSPM—Kubernetes security posture manager: what security problems exist in Kubernetes clusters\n” \ “2-CSPM-Cloud security posture management: a tool that describes problems in deployed clusters on various clouds\n” \ “5—data security—tools to find specific problems related to data handling inside applications\n” \ “9—webex team space—a collaboration messaging tool that helps connect between teams to communicate over the Internet \n” \ “6—API security—a tool that finds security problems in the use and definition of API-based services inside or outside the application\n” \ “\n” \ “The order in which the tools must be presented is by priority order\n” \ “\n” \ “Note that not all tools are security tools and note that multiple tools can be part of the answer. \n” \ “I need you to give me the best tools categories that go with the user prompts. Do not hallucinate and if “\” you don't know the answer, say ‘i don't know’. Only provide the name of the category and do not provide an explanation “\” what the category docs.\n″}.

UI 150 of system 100 represents the point of contact between user device 160 and user 170. UI 150 may include any technology user 170 interacts with, such as screens, sounds, overall style, and responsiveness. UI 150 includes one or more UI elements 152.

UI element 152 of system 100 represents a building block for UI 150. In certain embodiments, UI element 152 adds interactivity to UI 150 by providing a touch point for user 170. In some embodiments, UI element 152 is used to generate a visual language that is easily understood and/or navigated by user 170. UI element 152 may include a navigational element, an input control, an informational component, a container, and the like.

A navigational element is used to assist user 170 with navigation. Examples of navigational elements include slide bars, search fields, tags, icons, back arrows, and so on. An input control is an on-page element that allow user 170 to input information. Examples of input controls include text inputs, buttons, checkboxes, dropdown menus, links, tabs, text fields, and the like. An informational component is used to communicate information to user 170. Examples of information elements include progress bars, tooltips, icons, notifications, message boxes, and the like. A container is a layout element that is used to group and organize other UI elements (e.g., text, buttons, etc.). In certain embodiments, containers provide structure and hierarchy to the overall layout. Examples of containers include sectional containers, grid containers, card containers, modal containers, etc. In certain embodiments, UI element 152 is associated with context 154.

Context 154 of system 100 represents information that is relevant to UI element 152. In certain embodiments, context 154 refers to the circumstances and/or situation surrounding a communication that may affect the communication's meaning and/or interpretation. In some embodiments, context 154 includes information from different sources and/or programmers. Examples of context 154 include a text message, an image, a video, a tag, an identification of UI 150, an identification of UI element 152, an identification of an API, a combination thereof, and so on.

In certain embodiments, context 154 represents any object implemented by any service. For example, context 154 may represent a rendered object associated with a service identifier. AI assistant 156 can then interact with the service to obtain information associated with the rendered object. In some embodiments, system 100 onboards the service by way of its specification to AI assistant 156.

In certain embodiments, security tool 130 maintains a series of historical prompts and their associated responses in a session for static and/or dynamic data as context 154. This type of context 154 may form the basis for formulating new queries. In particular embodiments, context 154 for the security queries may be extended with user selectable information through UI 150 of security tool 130.

Context 154 may be split and/or cloned to allow security personnel to deep dive into solutions. In some embodiments, context 154 is shared across multiple users 170 to allow a team (e.g., a security team) to jointly work on a problem (e.g., a security problem). In certain embodiments, AI assistant 156 is a member of that team.

AI assistant 156 of system 100 represents software empowered by AI that generates tailored human-like responses. In certain embodiments, AI assistant 156 leverages language models 140. AI assistant 156 may perform a range of tasks and/or services for user 170 based on user input. User input may include written and/or verbal questions, commands, etc. In certain embodiments, AI assistant 156 includes chatbot capabilities to simulate human conversation and facilitate interaction with user 170. AI assistant 156 may interact with user 170 via texts (e.g., online chat such as chat box, Short Message Service (SMS) text, e-mail, etc.), graphical interfaces, images, voice commands, a combination thereof, or any other suitable means of communication. In certain embodiments, user 170 asks AI assistant 156 questions via text or voice input. AI assistant 156 may use natural language processing (NLP) to match the text or voice input of user 170 to executable commands. AI assistant 156 may continuously learn using AI techniques such as machine learning and ambient intelligence. In some embodiments, AI assistant 156 captures the interaction of context 154.

In certain embodiments, AI assistant 156 is a multi-modal AI. For example, user 170 may select (e.g., click on or move cursor over) a discovered vulnerability and ask AI assistant 156 to tell user 170 more about the vulnerability. AI assistant 156, as a multi-modal AI, may respond with text, pictures, videos, speech, or any other suitable form of response. As another example, AI assistant 156 may display a specific attack path to user 170, and user 170 may interact with AI assistant 156, such as discussing the role of a cloud platform (e.g., what makes this role critical, and why this finding is critical in the attack path).

In certain embodiments, AI assistant 156 determines whether to generate a response to an inquiry, or whether it is more beneficial to leverage an existing tool to provide the response. In some embodiments, AI assistant 156 is completely aware of UI 150 within which it is housed. Axes of UI understanding with example utterances may include one or more of the following: semantically, what things mean (e.g., “This represents a pod with a vulnerability”); navigationally, where features are (e.g., “Use the menu called foo and then choose the option bar”); spatially, where features are on the current display (e.g., “The button on the right below the list”); visually, how features look (e.g., “The red icon in the list”); operationally, how features interact (e.g., “Double click that control” or “let me scroll that into view”); temporally, the history of UI interactions (e.g., “The screen before this one”); and so on.

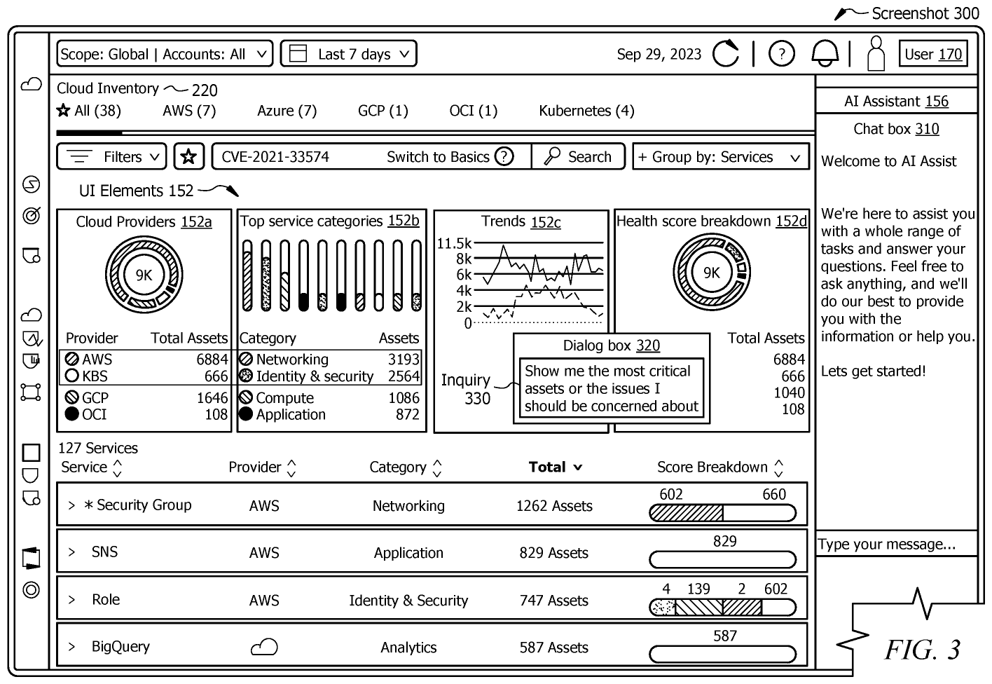

In certain embodiments, AI assistant 156 is linear or tree-like in structure. Multiple contexts 154 may be used that allow user 170 (e.g., via chat box 310 of FIG. 3) to move throughout a chat conversation. An existing conversation may be folded into discussed topics. In some embodiments, AI assistant 156 is pre-primed from application 122 (e.g., WebEx). User 170 of system 100 may interact with AI assistant 156 via user device 160.

User device 160 of system 100 includes any user equipment that can receive, create, process, store, and/or communicate information. User device 160 may include one or more workstations, desktop computers, laptop computers, mobile phones (e.g., smartphones), tablets, personal digital assistants (PDAs), wearable devices, and the like. In certain embodiments, user device 160 includes a liquid crystal display (LCD), an organic light-emitting diode (OLED) flat screen interface, digital buttons, a digital keyboard, physical buttons, a physical keyboard, one or more touch screen components, a graphical UI (GUI), and/or the like. User device 160 may be located in any suitable location to receive and communicate information to user 170 of system 100.

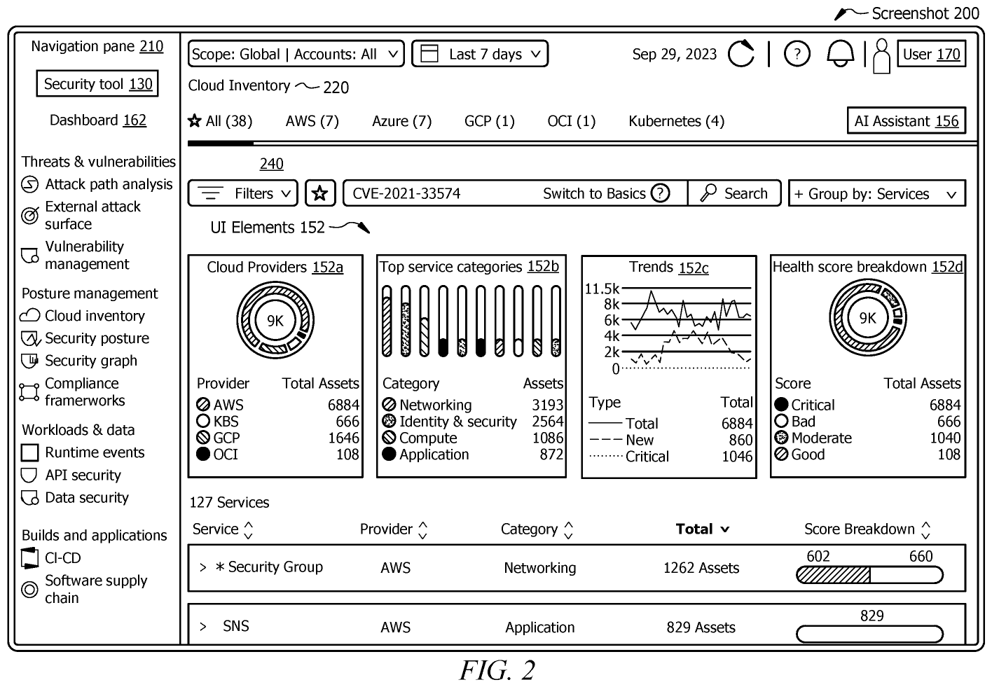

Dashboard 162 of system 100 represents a visualization of multiple data sources through numbers, graphs, charts, and the like. In certain embodiments, dashboard displays data based on a theme (e.g., an account) or summarizes data points for a high-level overview in a snapshot. In certain embodiments, dashboard 162 uses UI elements (e.g., UI elements 152 of FIG. 2) to display information to user 170.

User 170 of system 100 is a person or group of persons who utilizes user device 160 of system 100. User 170 may be associated with one or more accounts. User 170 may be a local user, a remote user, an administrator, security personnel, a customer, a company, a combination thereof, and the like. User 170 may be associated with a username, a password, a user profile, etc.

In operation, security tool 130 displays one or more available UI elements 152 to user 170 via UI 150. AI assistant 156 of security tool 130 receives a selection of a particular UI element 152 from user 170 via UI 150 in the form of an identifier. AI assistant 156 determines context 154 associated with UI element 152 by determining a service associated with the identifier, onboarding the service, and generating a call to the service to obtain context 154. UI element 152 may be an input control, a navigational component, an informational component, a container, or any other suitable type of UI element 152. Context 154 may be a text message, an image, a video, a tag, or any other suitable type of context 154.

AI assistant 156 of security tool 130 also receives an inquiry associated with UI element 152 via UI 150. For example, user 170 may type an inquiry (e.g., a question) into a chat box of UI 150, and AI assistant 156 may receive the inquiry from the chat box. AI assistant 156 associates the inquiry with context 154. UI 150 communicates the inquiry and context 154 to one or more language models 140 (e.g., LLM 142 and SLM 144), and one or more language models 140 generate a response to the inquiry. For example, SLM 144 may be trained with specifics of APIs and their associated rules and use this training to decipher the context to assist LLM 142 with generating the response to the inquiry. LLM 142 may then communicate the response to UI 150. UI 150 may share the response to the inquiry with one or more other UIs 150 that are authorized to display the context and response to the inquiry. As such, security tool 130 combined with AI assistant 156 may be used to assist security personnel in better formulating security queries, combining static and dynamic security information in new ways, and automatically remediating security issues.

Although FIG. 1 illustrates a particular number of networks 110, cloud resources 120, applications 122, security tools 130, language models 140 (LLMs 142 and SLMs 144), UIs 150, UI elements 152, contexts 154, AI assistants 156, user devices 160, dashboards 162, and users 170, this disclosure contemplates any suitable number of networks 110, cloud resources 120, applications 122, security tools 130, language models 140 (LLMs 142 and SLMs 144), UIs 150, UI elements 152, contexts 154, AI assistants 156, user devices 160, dashboards 162, and users 170. For example, system 100 may include more than cloud resource 120 and/or more than one application 122.

Although FIG. 1 illustrates a particular arrangement of network 110, cloud resource 120, application 122, security tool 130, language models 140 (LLM 142 and SLM 144), UI 150, UI element 152, context 154, AI assistant 156, user device 160, dashboard 162, and user 170, this disclosure contemplates any suitable arrangement of network 110, cloud resource 120, application 122, security tool 130, language models 140 (LLM 142 and SLM 144), UI 150, UI element 152, context 154, AI assistant 156, user device 160, dashboard 162, and user 170.

Furthermore, although FIG. 1 describes and illustrates particular components, devices, or systems carrying out particular actions, this disclosure contemplates any suitable combination of any suitable components, devices, or systems carrying out any suitable actions.

FIG. 2 illustrates a screenshot 200 of AI assistant 156 used by system 100 of FIG. 1, in accordance with certain embodiments. In the illustrated embodiment of FIG. 2, screenshot 200 displays dashboard 162 of security tool 130 of FIG. 1. Screenshot 200 shows navigation pane 210, cloud inventory 220, and UI elements 152. Navigation pane 210 is a narrow vertical bar on the left edge of dashboard 162 that includes selections (e.g., buttons) that allow user 170 to switch quickly between various tabs (threats and vulnerabilities, posture management, workloads and data, an builds and applications) and subtabs (attack path analysis, external attack surface, vulnerability management, cloud inventory, security posture, security graph, compliance frameworks, runtime events, API security, data security, CI-CD, and software supply chain). In the illustrated embodiment of FIG. 2, the subtab for cloud inventory 220 has been selected.

Cloud Inventory 220 provides real-time visibility into assets across different cloud providers. Cloud providers represent third-party entities that provide scalable computing cloud resources (e.g., cloud resource 120 of FIG. 1) that can be accessed on demand via a network (e.g., network 110 of FIG. 1). Cloud providers may provide cloud-based computing services, storage, cloud platforms, application services, etc. Assets within cloud inventory 220 can be filtered (see filters tab 240) by a number of parameters (e.g., service, provider, category, account, risk severity, risk score, user actions, labels, risk engine, region, and favorites). In the illustrated embodiment of FIG. 2, cloud inventory 220 includes a horizontal list of the following cloud providers: AWS, Azure, GCP, OCI, and Kubernetes.

UI elements 152 of screenshot 200 represent elements of a graphical UI that display information and/or provide a specific way for user 170 to interact with an operating system (OS) or an application. UI elements 152 may represent information in different forms. For example, UI elements 152 may represent information in the form of lines, bars, bubble charts, pies, numbers, gauges, stacked columns, tree maps, heat maps, data grids, range bars, a combination thereof, etc. In the illustrated embodiment of FIG. 2, UI elements 152 include cloud providers UI element 152a, top service categories UI element 152b, trends UI element 152c, and health score breakdown UI element 152d.

Cloud providers UI element 152a displays the total number of assets in an environment, by provider. In the illustrated embodiment of FIG. 1, cloud providers UI element 152a lists the following cloud providers: AWS, Kubernetes, GCP, and OCI. AWS is associated with 6884 total assets, Kubernetes is associated with 666 total assets, GCP is associated with 1646 total assets, and OCI is associated with 108 total assets.

Top service categories UI element 152b depicts the most common category of assets per service category. Top service categories UI element 152b lists the following service categories in descending order based on number of corresponding assets: networking, identity and security, compute, and application. The networking service category is associated with 3193 assets, the identity and security service category is associated with 2564 assets, the compute category is associated with 1086 assets, and the application category is associated with 872 assets.

Trends UI element 152c displays the asset status over time. In the illustrated embodiment of FIG. 2, trends UI element 152c indicates a percent change of total, new, and critical results according to attach paths or findings. The total number of results is 6884, the number of new results is 666, and the number of critical results is 1646. Trends UI element 152c helps to track workflow and assess cloud security progress.

Health score breakdown UI element 152d provides a breakdown of the number of assets having the following health scores: critical, bad, moderate, and good. In the illustrated embodiment of FIG. 1, 6884 assets have a critical health score, 666 assets have a bad health score, 1646 assets have a moderate health score, and 108 assets have a good health score.

In the illustrated embodiment of FIG. 2, AI assistant 156 (as described in FIG. 1 above) is in the form of a button. A button is an interactive element that facilitates actions of user 170. To activate AI assistant 156, user selects the button with the AI assistant 156. Upon activation, AI assistant may generate a chat box and/or a dialog box, as described below in FIG. 3.

FIG. 3 illustrates a screenshot 300 of a chat box 310 and a dialog box 320 used by AI assistant 156 to communicate with user 170, in accordance with certain embodiments. In the illustrated embodiment of FIG. 3, screenshot 300 displays dashboard 162 of security tool 130 of FIG. 1. Screenshot 300 shows cloud inventory 220, UI elements 152, AI assistant 156, and user 170, which are described above in FIG. 2.

Chat box 310 is a vertical bar on the right edge of screenshot 300 that includes a text input field for user 170 to input (e.g., type in) a message. In certain embodiments, chat box 310 includes one or more buttons that allow user 170 to initiate a chat with AI assistant 156. In some embodiments, when user 170 selects (e.g., clicks on or moves cursor over) the button for AI assistant 156 shown in FIG. 2 above, chat box 310 automatically appears. Chat box 310 may pre-populate with quick select prompts. In some embodiments, chat box 310 automatically generates a message to initiate a conversation with user 170. The automatically generated message may be an introductory message, an informational message, or any other suitable type of message. In the illustrated embodiment of FIG. 3, chat box 310 automatically generated the following introductory/informational message: “Welcome to AI Assist. We're here to assist you with a wide range of tasks and answer your questions. Feel free to ask anything, and we'll do our best to provide you with the information or help you need. Let's get started!”. In certain embodiments, chat box 310 is a window (e.g., a display window, a popup window, etc.) on a website through which user 170 interacts with AI assistant 156.

Dialog box 320 represents a graphical control element in the form of a small window that communicates information to user 170 and/or prompts user 170 for input. For example, dialog box 320 may be a context-based prompt that allows user 170 to select an item (e.g., UI element 152) in the UI (e.g., UI 150 of FIG. 1) and ask questions related the item. In some embodiments, when user 170 selects (e.g., clicks on or moves cursor over) the button for AI assistant 156 shown in FIG. 2 above, dialog box 320 automatically appears. In the illustrated embodiment of FIG. 3, dialog box 320 is located near the center of screenshot 300 and includes a text input field for user 170 to input (e.g., type in) a message. Dialog box 320 communicates the following prompt to user 170: “Ask me anything”.

In certain embodiments, dialog box 320 receives input in the form of an inquiry 330 from user 170. Inquiry 330 represents a request for information. In the illustrated embodiment of FIG. 3, user 170 entered the following inquiry 330 into dialog box 320: “Show me the most critical assets or the issues I should be concerned about.” In some embodiments, dialog box 320 receives a selection 340 of a UI element (e.g., UI element 152 of FIG. 1) from user 170. Selection 340 is any part of the UI illustrated in screenshot 300. For example, selection 340 may represent a selection of security score UI element 152e, trends UI element 152c, compliance UI element 152f, or runtime UI element 152g.

In certain embodiments, context 154 related to selected UI element 152 is forwarded to a language model (e.g., language model 140 of FIG. 1) along with inquiry 330 entered by user 170 in relation to selected UI element 152. Context 154 that is captured in UI 150 may be communicated via a post request payload along with inquiry 330 to a backend of security tool 130. When a context-based prompt is generated in the frontend (e.g., via dialog box 320 or chat box 310), an API call may be generated and communicated to the backend of security tool. For example, the post request may include the following payload in the body: {question: “The question”, context: {id: “represents the item in the UI that the user is interested in.” metadata: “some metadata about the UI that will help answer the question asked.”}}.

The identification (id) allows the backend of security tool 130 to interpret which UI element 152 is in context 154 and whether the system is aware of such UI element 152. The metadata is useful for the language models to understand inquiry 330 (e.g., the question) and build an appropriate response (e.g., the answer).

FIG. 4 illustrates another screenshot 400 of a chat box 310 and dialog box 320 used by AI assistant 156 to communicate with user 170, in accordance with certain embodiments. In the illustrated embodiment of FIG. 4, screenshot 400 displays dashboard 162 of security tool 130 of FIG. 1. Screenshot 400 shows trends UI element 152c, AI assistant 156, user 170, chat box 310, dialog box 320, and inquiry 330, which are described above in FIG. 2 and FIG. 3. In addition to trends UI element 152c, screenshot 400 shows the following UI elements 152: a security score UI element 152e, a compliance UI element 152f, and a runtime UI element 152g.

Security score UI element 152e displays the overall health score of a cloud environment, as well as that of each account. The security score is aggregated from the health score of each individual asset in those accounts. In the illustrated embodiment of FIG. 4, the overall health score is 76, and the health score of account rosey is 71.

Compliance UI element 152f reports how resources are scoring against a major compliance framework such as the Health Insurance Portability and Accountability Act (HIPAA), General Data Protection Regulation GDPR, etc. No data is shown for compliance UI element 152f in the illustrated embodiment of FIG. 4.

Runtime UI element 152g scans a cloud environment for any attacks happening in real time. If the asset is compromised, an alert will appear, allowing user 170 to address the issue immediately. In the illustrated embodiment of FIG. 4, the types of scans include a malware scan and an AWS GuardDuty scan.

Screenshot 400 illustrates an attack path flow 410. Attack path flow 410 allows user 170 to visualize the flow from any risk engine and/or any severity level to the prioritized attack path. In certain embodiments, attack path flow 410 is visually highlighted with proportional currents to the number of attack paths detected as grouped by order of severity. In the illustrated embodiment of FIG. 4, attack path flow 410 shows 110 vulnerabilities and 14 configuration risks.

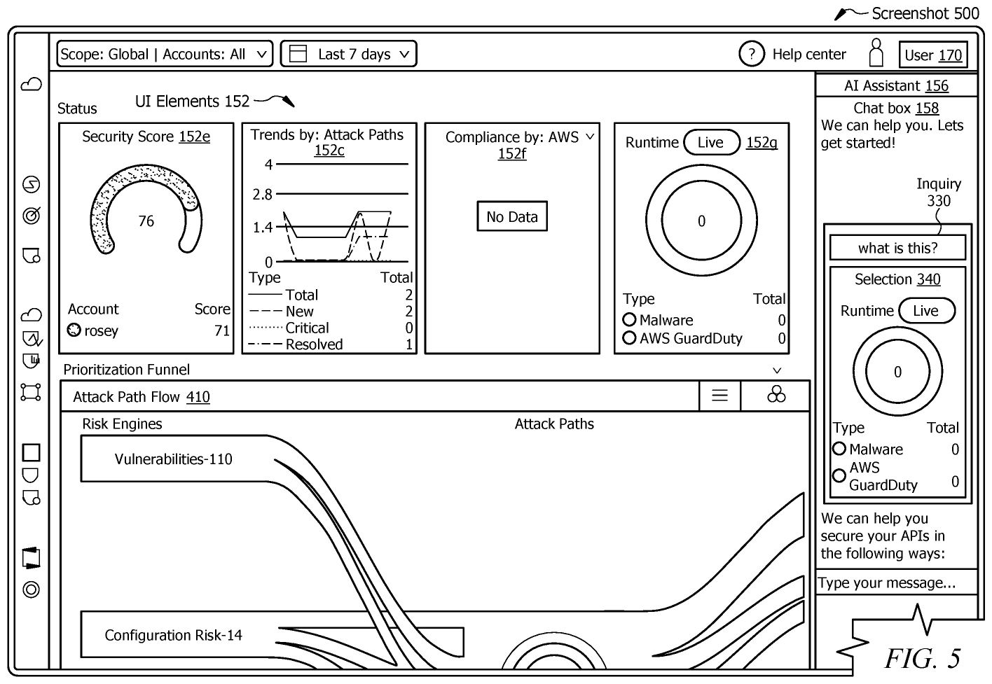

FIG. 5 illustrates a screenshot 500 of chat box 310 used by AI assistant 156 that includes inquiry 330 input by user 170 and selection 340 selected by user 170, in accordance with certain embodiments. In the illustrated embodiment of FIG. 5, screenshot 500 displays dashboard 162 of security tool 130 of FIG. 1. Screenshot 500 shows UI elements 15c, AI assistant 156, user 170, chat box 310, dialog box 320, and inquiry 330, which are described above in FIGS. 2 through 4.

In the illustrated embodiment of FIG. 5, AI assistant 156 receives inquiry 330 and selection 340 from user 170. Inquiry 330 is in the form of a question: “what is this?”, and selection 340 is runtime UI element 152g. In certain embodiments, user 170 inputs inquiry 330 and selection 340 using chat box 310 and/or dialog box 320. For example, user 170 may type “what is this?” into dialog box 320, as illustrated in FIG. 4, and input selection 340 by selecting the icon in dialog box 320 and then selecting runtime UI element 152g. As another example, user 170 may type “what is this?” in chat box 310, and then select and drag runtime UI element 152g into chat box 310.

Chat box 310 of FIG. 5 receives input in the form of inquiry 330 and selection 340 of runtime UI element 152g from user 170. AI assistant 156 determines the context (e.g., context 154 of FIG. 1) related to runtime UI element 152g and forwards the context and inquiry 330 to one or more language models (e.g., language models 140 of FIG. 1). The one or more language models then interpret the context and inquiry 330 and generate a response. For example, the one or more language models may generate a response explaining runtime UI element 152g. An example response may be as follows: “the Runtime widget scans your cloud environment for any attacks happening in real time. If one of your assets is compromised, an alert will appear, allowing you to address the issue immediately.”.

Although FIGS. 2 through 5 illustrate a particular number of security tools 130, UI elements 152, AI assistants 156, dashboards 162, users 170, navigation panes 210, cloud inventories 220, chat boxes 310, dialog boxes 320, inquiries 330, and selections 340, this disclosure contemplates any suitable number of security tools 130, UI elements 152, AI assistants 156, dashboards 162, users 170, navigation panes 210, cloud inventories 220, chat boxes 310, dialog boxes 320, inquiries 330, and selections 340.

Although FIGS. 2 through 5 illustrate a particular arrangement of elements within screenshots 200 through 500, this disclosure contemplates any suitable arrangement of elements within screenshots 200 through 500. For example, navigation pane 210 may be located on the right edge of screenshot 200. As another example, AI assistant 156 may be located on the left edge of screenshots 200 through 500.

Furthermore, although FIGS. 2 through 5 describe and illustrate particular components, devices, or systems carrying out particular actions, this disclosure contemplates any suitable combination of any suitable components, devices, or systems carrying out any suitable actions.

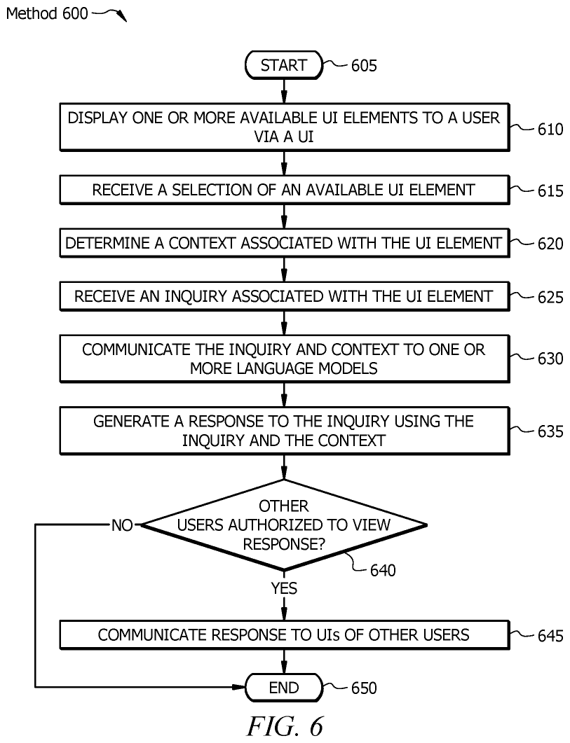

FIG. 6 illustrates an example method 600 for expanding the security context of AI. Method 600 begins at step 605. At step 610 of method 600, a UI displays one or more available UI elements 152 to user 170. For example, referring to FIGS. 1 and 2, UI 150 may display four UI elements 152 to user 170 via dashboard 162. Available UI elements include input controls, navigational components, informational components, containers, or any other suitable types of UI elements. In certain embodiments, all features displayed on dashboard 162 are associated with a UI element that is available for selection. In some embodiments, only some of the features displayed on dashboard 162 are associated with a UI element that is available for selection. Method 600 then moves from step 610 to step 615.

At step 615 of method 600, the UI receives a selection of an available UI element from the user. For example, referring to FIG. 1, user 170 may either click on or move their cursor over available UI element 152 (e.g., an attack path), and UI 150 may receive the selection of UI element 152 in response to the input from user 170. Method 600 then moves from step 615 to step 620.

At step 620 of method 600, the UI determines a context associated with the UI element. The context may be a text message, an image, a video, a tag, or an identification of the UI element, an identification of one or more APIs, or any other suitable type of context. For example, referring to FIG. 1, UI 150 may determine that context 154 associated with attack path UI element 152 includes an identification (id) of the attack path.

In certain embodiments, the context represents any object implemented by any service. For example, the context may represent a rendered object associated with a service identifier. The AI assistant can then interact with the service to obtain information associated with the rendered object. In some embodiments, the service is onboarded by way of its specification to the AI assistant. Method 600 then moves from step 620 to step 625.

At step 625 of method 600, AI assistant 156 receives an inquiry associated with UI element 152. For example, referring to FIG. 3, user 170 may type inquiry 330 (e.g., a question) into chat box 310, and AI assistant 156 may receive inquiry 330 from chat box 310. Method 600 then moves from step 625 to step 630, where the AI assistant communicates the inquiry and the context to one or more language models. For example, referring to FIG. 1, UI 150 may communicate the inquiry (e.g., “What is this?”) and the context (e.g., an identification of the attack path) to one or more language models 140 (e.g., LLM 142 and SLM 144). Method 600 then moves from step 630 to step 635.

At step 635 of method 600, the one or more language models generates a response to the inquiry. For example, referring to FIG. 1, one or more language models 140 may generate a response explaining what UI element 152 (e.g., the attack path) represents. In certain embodiments, an SLM (e.g., SLM 144) may be trained with specifics of APIs and their associated rules and may use this training to decipher the context to assist LLM 142 with generating the response to the inquiry. Method 600 then moves from step 635 to step 640, where the language model communicates the response to the UI. For example, referring to FIG. 1, UI 150 may communicate an explanation of the attack path to user 170 via chat box 310. Method 600 then moves from step 640 to step 645.

At step 645 of method 600, the security tool determines whether other users are authorized to view the response. For example, referring to FIG. 1, user 170 may be part of a security team, and one or more other users 170 of the security may be authorized to view the generated response. If, at step 645, the security tool determines that other users are not authorized to view the response, method 600 advances from step 640 to step 650, where method 600 ends. However, if the security tool at step 645 determines that other users are authorized to view the response, method 600 moves from step 640 to step 645, where the AI assistant communicates the response to the other authorized users. Method 600 then moves to step 650, where method 600 ends. As such, the security tool combined with the AI assistant is used to expand the security context of AI, thereby assisting security personnel in better formulating security queries, combining static and dynamic security information in new ways, and automatically remediating security issues.

Although this disclosure describes and illustrates particular steps of method 600 of FIG. 6 as occurring in a particular order, this disclosure contemplates any suitable steps of method 600 of FIG. 6 occurring in any suitable order. Although this disclosure describes and illustrates an example method 600 for expanding the security context of AI including the particular steps of the method of FIG. 6, this disclosure contemplates any suitable method for expanding the security context of AI, which may include all, some, or none of the steps of the method of FIG. 6, where appropriate. Although FIG. 6 describes and illustrates particular components, devices, or systems carrying out particular actions, this disclosure contemplates any suitable combination of any suitable components, devices, or systems carrying out any suitable actions.

FIG. 7 illustrates an example computer system 700. In particular embodiments, one or more computer system 700 perform one or more steps of one or more methods described or illustrated herein. In particular embodiments, one or more computer system 700 provide functionality described or illustrated herein. In particular embodiments, software running on one or more computer system 700 performs one or more steps of one or more methods described or illustrated herein or provides functionality described or illustrated herein. Particular embodiments include one or more portions of one or more computer system 700. Herein, reference to a computer system may encompass a computing device, and vice versa, where appropriate. Moreover, reference to a computer system may encompass one or more computer systems, where appropriate.

This disclosure contemplates any suitable number of computer system 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer system 700; be unitary or distributed; span multiple locations; span multiple machines; span multiple data centers; or reside in a cloud, which may include one or more cloud components in one or more networks. Where appropriate, one or more computer system 700 may perform without substantial spatial or temporal limitation one or more steps of one or more methods described or illustrated herein. As an example and not by way of limitation, one or more computer system 700 may perform in real time or in batch mode one or more steps of one or more methods described or illustrated herein. One or more computer system 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), crasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer system 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a 3G network, a 4G network, a 5G network, an LTE network, or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A network component comprising one or more processors and one or more computer-readable non-transitory storage media coupled to the one or more processors and including instructions that, when executed by the one or more processors, cause the network component to perform operations comprising:
receiving a selection of a user interface (UI) element from a UI;
determining a context associated with the UI element;
receiving an inquiry associated with the UI element;
communicating the inquiry and the context to one or more language models; and
receiving, by the one or more language models, a response to the inquiry using the inquiry and the context.

2. The network component of claim 1, wherein:
receiving the selection of the UI element from the UI comprises receiving an identifier associated with the UI element; and
determining the context associated with the UI element comprises:
determining a service associated with the identifier;
onboarding the service; and
generating a call to the service to obtain the context.

3. The network component of claim 1, the operations further comprising:
receiving the inquiry from a chat box of the UI, wherein the inquiry comprises a question in the form of a natural language; and
associating the inquiry with the context.

4. The network component of claim 1, wherein the one or more language models comprise a large language model (LLM) and a small language model (SLM).

5. The network component of claim 4, the operations further comprising:
training the SLM with specifics of application programming interfaces (APIs) and their associated rules; and
deciphering, by the SLM, the context to assist the one or more language models with generating the response to the inquiry.

6. The network component of claim 1, the operations further comprising:
displaying one or more available UI elements to the user via the UI; and
receiving, in response to displaying the one or more available UI elements to the user via the UI, the selection of the context.

7. The network component of claim 1, the operations further comprising:
capturing the response to the inquiry; and
sharing the response to the inquiry with one or more other UIs that are authorized to display the context and response to the inquiry.

8. A method, comprising:
receiving a selection of a user interface (UI) element from a UI;
determining a context associated with the UI element;
receiving an inquiry associated with the UI element;
communicating the inquiry and the context to one or more language models; and
receiving, by the one or more language models, a response to the inquiry using the inquiry and the context.

9. The method of claim 8, wherein:
receiving the selection of the UI element from the UI comprises receiving an identifier associated with the UI element; and
determining the context associated with the UI element comprises:
determining a service associated with the identifier;
onboarding the service; and
generating a call to the service to obtain the context.

10. The method of claim 8, further comprising:
receiving the inquiry from a chat box of the UI, wherein the inquiry comprises a question in the form of a natural language; and
associating the inquiry with the context.

11. The method of claim 8, wherein the one or more language models comprise a large language model (LLM) and a small language model (SLM).

12. The method of claim 11, further comprising:
training the SLM with specifics of application programming interfaces (APIs) and their associated rules; and
deciphering, by the SLM, the context to assist the one or more language models with generating the response to the inquiry.

13. The method of claim 8, further comprising:
displaying one or more available UI elements to the user via the UI; and
receiving, in response to displaying the one or more available UI elements to the user via the UI, the selection of the context.

14. The method of claim 8, further comprising:
capturing the response to the inquiry; and
sharing the response to the inquiry with one or more other UIs that are authorized to display the context and response to the inquiry.

15. One or more computer-readable non-transitory storage media embodying instructions that, when executed by a processor, cause the processor to perform operations comprising:
receiving a selection of a user interface (UI) element from a UI;
determining a context associated with the UI element;
receiving an inquiry associated with the UI element;
communicating the inquiry and the context to one or more language models; and
receiving, by the one or more language models, a response to the inquiry using the inquiry and the context.

16. The one or more computer-readable non-transitory storage media of claim 15, wherein:
receiving the selection of the UI element from the UI comprises receiving an identifier associated with the UI element; and
determining the context associated with the UI element comprises:
determining a service associated with the identifier;
onboarding the service; and
generating a call to the service to obtain the context.

17. The one or more computer-readable non-transitory storage media of claim 15, the operations further comprising:
receiving the inquiry from a chat box of the UI, wherein the inquiry comprises a question in the form of a natural language; and
associating the inquiry with the context.

18. The one or more computer-readable non-transitory storage media of claim 15, wherein the one or more language models comprise a large language model (LLM) and a small language model (SLM).

19. The one or more computer-readable non-transitory storage media of claim 18, the operations further comprising:
training the SLM with specifics of application programming interfaces (APIs) and their associated rules; and
deciphering, by the SLM, the context to assist the one or more language models with generating the response to the inquiry.

20. The one or more computer-readable non-transitory storage media of claim 15, the operations further comprising:
displaying one or more available UI elements to the user via the UI; and
receiving, in response to displaying the one or more available UI elements to the user via the UI, the selection of the context.
